(19) United States
(12) Patent Application Publication
(10) Pub. No.: US 2006/0086926 A1
(43) Pub. Date: Apr. 27, 2006

(54) Solvent for tack free treating agent for perfluoroelastomer, and tack free treating agent solution using the same

(75) Inventor: Katsuhiro Wakui, Sagamihara (JP)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/230,853

(22) Filed: Sep. 20, 2005

(30) Foreign Application Priority Data
Oct. 25, 2004 (JP) 2004-309858

(51) Int. Cl. B01F 1/00

(52) U.S. Cl. 252/364

(57) ABSTRACT

A solvent which can well dissolve a tack free treating agent and also can swell a perfluoroelastomer, and a tack free treating agent using the same are provided. A solvent for tack free treating agent for perfluoroelastomer, comprising hydrofluoromonoether represented by CₙF₂ₙ₊₁—O—CₘH₂ₘ₊₁ wherein n is from 3 to 7, CₙF₂ₙ₊₁ may be linear or branched, and m is from 1 to 2, and a specific organic solvent are also provided.

This application claims priority from Japanese Patent Application Serial No. 2004-309858, filed on Oct. 25, 2004.

### TECHNICAL FIELD

The present application relates to a solvent for tack free treating agent for perfluoroelastomer, and a tack free treating agent solution using the same.

### BACKGROUND

Perfluoroelastomers may be used as a sealing material for semiconductor equipment (for example, dry etching system, CVD system and the like) because of its excellent plasma resistance, chemical resistance and heat resistance. However, it is very difficult to subject the perfluoroelastomer to a surface treatment such as tack free treatment because of its physical properties.

Methods for tack free treating of an elastomer or rubber include adding tack-free property imparting fillers such as fluororesin and SiO₂. However, original physical properties of the elastomer or rubber may be impaired by the addition of these fillers. A second method involves physically or chemically polishing the surface by plasma exposure to impart tack-free property and to increase the surface area to enhance an adhesive strength of an adhesive. However, such a polishing process causes a problem that the surface of the elastomer or rubber is damaged and fine cracks occur during use. Since particles are released from the treated surface, the treated elastomer or rubber is not suited for use as semiconductors. Yet another method requires coating the surface of the rubber with a resin made of a different material. However, the coating resin tends to separate from the fluoroelastomer, especially perfluoroelastomers, due to the low affinity of fluoroelastomers for other materials. Finally, one method includes excessively crosslinking only the surface of the rubber. However, it is difficult to excessively crosslink the fluoroelastomer because of restriction of its crosslink point.

Other treatment methods are also available. For example, a surface treatment agent may be dissolved in a solvent capable of swelling an elastomer or rubber and a rubber is then immersed in the solution, thereby impregnating the swollen rubber with the surface treatment agent. This method has been studied for non-perfluoroelastomer-based rubbers and specific formulations for perfluoroelastomer are not described in the prior art. The perfluoroelastomer can not be swollen by the exemplified solvents in the prior art.

As described above, it is very difficult to conduct a tack free treatment of the perfluoroelastomer. The perfluoroelastomer is a rubber material that may have excellent chemical resistance to almost all inorganic and organic materials. In other words, it is difficult to coat the surface with almost all of different materials. Among the techniques described above, a method for penetration of a treating agent by means of swelling is considered to be effective. However, solvents capable of swelling a perfluoroelastomer are only perfluoro-based solvents, a conventional organic solvent can not swell a perfluoroelastomer. The perfluoro-based solvent can swell the perfluoroelastomer, but can not dissolve a tack free treating agent. Consequently, a swelling and penetration method could not be used because the tack free treating agent can not be dissolved:

### SUMMARY OF THE INVENTION

The present invention relates to a solvent which can well dissolve a silicone-based tack free treating agent and also can swell a perfluoroelastomer, and a tack free treating agent using the same.

According to an aspect of the present invention, there is provided a solvent for tack free treating agent for perfluoroelastomer, comprising:
a hydrofluoromonoether represented by CₙF₂ₙ₊₁—O—CₘH₂ₘ₊₁ wherein n is from 3 to 7, CₙF₂ₙ₊₁ may be linear or branched, and m is from 1 to 2, and
at least one organic solvent selected from the group consisting of methanol, ethanol, isopropanol (IPA), 1-propanol, t-butyl methyl ether, tetrahydrofuran, diethyl ether, ethyl acetate, butyl acetate, propyl acetate, pentane, hexane, heptane, acetone, methyl ethyl ketone (MEK), methyl isobutyl ketone (MIBK), cyclohexanone, trans-1,2-dichloroethylene, 1,2-dichloropropane, methylene chloride, trichloroethylene, perchloroethylene, toluene, xylene, trifluorotoluene, and hexafluoroxylene.

According to another aspect of the present invention, there is provided a solvent for tack free treating agent for perfluoroelastomer, comprising:
hydrofluoromonoether represented by CₙF₂ₙ₊₁—O—CₘH₂ₘ₊₁ (wherein n is from 3 to 7, CₙF₂ₙ₊₁ may be linear or branched, and m is from 1 to 2),
a perfluoro-based solvent represented by the following formula: 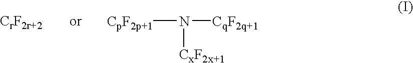
   wherein r is from 4 to 10, p is from 1 to 8, q is from 1 to 8, x is from 1 to 8, and p+q+x=6 to 10, and
at least one organic solvent selected from the group consisting of methanol, ethanol, isopropanol (IPA), 1-propanol, t-butyl methyl ether, tetrahydrofuran, diethyl ether, ethyl acetate, butyl acetate, propyl acetate, pentane, hexane, heptane, acetone, methyl ethyl ketone (MEK), methyl isobutyl ketone (MIBK), cyclohexanone, trans-1,2-dichloroethylene, 1,2-dichloropropane, methylene chloride, trichloroethylene, perchloroethylene, toluene, xylene, trifluorotoluene, and hexafluoroxylene.

According to still another aspect of the present invention, there is provided a tack free treating agent solution for perfluoroelastomer, comprising one of the above solvents and a silicone-based tack free treating agent.

### DETAILED DESCRIPTION OF THE INVENTION

The hydrofluoromonoether-based solvent can dissolve a silicone-based tack free treating agent and also can swell a perfluoroelastomer when contacted with the elastomer. Consequently, it is possible to obtain a tack free surface by uniformly introducing a tack free treating agent in the vicinity of the surface of the perfluoroelastomer.

The solvent for tack free treating agent for perfluoroelastomer of the present invention (hereinafter referred to as a “solvent mixture for tack free treating agent” or merely referred to as a “solvent mixture”) contains hydrofluoromonoether represented by CₙF₂ₙ₊₁—O—CₘH₂ₘ₊₁ wherein n is from 3 to 7, CₙF₂ₙ₊₁ may be linear or branched, and m is from 1 to 2. The hydrofluoromonoether imparts affinity with the perfluoroelastomer to the solvent mixture and may also have sufficient miscibility with an organic solvent as the other component. The hydrofluoromonoether used in the present invention has a perfluorocarbon group at one side of an ether oxygen. Therefore, affinity with the perfluoroelastomer is enhanced and the solvent mixture swells the elastomer, thus making it possible to penetrate the tack free treating agent into the elastomer. The hydrofluoromonoether has a non-fluorinated alkyl group at the opposite side of an ether oxygen. This non-fluorinated alkyl group may enhance the miscibility with an organic solvent as the other component. It is believed that miscibility between the perfluoroelastomer and the solvent mixture is more enhanced as n increases. When n is too large, however, the boiling point of the hydrofluoromonoether increases, thus making it difficult to evaporate the solvent after application of the tack free treating agent. Therefore, n should preferably be set within an appropriate range, for example, from 3 to 7. On the other hand, miscibility with the other organic solvent is more enhanced as m increases. When m is too large, affinity with the perfluoroelastomer deteriorates. Therefore, m may be 1 or 2, that is, the non-fluorinated alkyl group may be either methyl or ethyl.

The amount of the hydrofluoromonoether in the solvent mixture is preferably from 40 to 80% by weight based on the total weight of the solvent mixture. When the amount of the hydrofluoromonoether is too large, miscibility with the organic solvent as the other component deteriorates, and thus making it difficult to dissolve the silicon-based tack free treating agent. On the other hand, when the amount is too small, an ability of swelling the perfluoroelastomer deteriorates, making it difficult to assist penetration of the treating agent into the elastomer and to perform a tack free treatment.

The solvent mixture of the present description contains at least one organic solvent selected from the group consisting of methanol, ethanol, isopropanol (IPA), 1-propanol, t-butyl methyl ether, tetrahydrofuran, diethyl ether, ethyl acetate, butyl acetate, propyl acetate, pentane, hexane, heptane, acetone, methyl ethyl ketone (MEK), methyl isobutyl ketone (MIBK), cyclohexanone, trans-1,2-dichloroethylene, 1,2-dichloropropane, methylene chloride, trichloroethylene, perchloroethylene, toluene, xylene, trifluorotoluene, hexafluoroxylene, and the like. The above organic solvents have excellent miscibility with the hydrofluoromonoether and also enable the solvent mixture to dissolve the silicone-based tack free treating agent. The organic solvent is contained in an amount of 20 to 60% by weight based on the total weight of the solvent mixture. When the amount of the organic solvent is too small, it becomes difficult to dissolve the silicone-based tack free treating agent. On the other hand, when the amount is too large, it becomes difficult to swell the perfluoroelastomer by the solvent mixture, and to penetrate the tack free treating agent.

The solvent mixture of the present invention may contain a perfluoro-based solvent represented by the following formula: 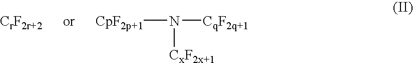
wherein r is from 4 to 10, p is from 1 to 8, q is from 1 to 8, x is from 1 to 8, and p+q+x=6 to 10, in addition to the hydrofluoromonoether. This component may further enhance swellability of the perfluoroelastomer. However, when the amount is too large, the perfluoro-based solvent may not be miscible with the other organic solvent and the solvent mixture may not be able to dissolve the tack free treating agent. Therefore, the perfluoro-based solvent may preferably be contained in an amount of not more than 10% by weight based on the total weight of the solvent mixture.

The tack free treating agent solution for perfluoroelastomer can be obtained by dissolving the tack free treating agent in the solvent mixture of the present description. The tack free treating agent is preferably a silicon-based tack free treating agent and is usually a polymer comprising or consisting of a dimethylsiloxane repeating unit.

The perfluoroelastomer to be treated with the tack free treating agent of the present description is not specifically limited and may be a conventional perfluoroelastomer. A main monomer unit constituting the perfluoroelastomer is preferably a combination of perfluoroolefins and perfluorovinyl ethers.

Examples of perfluoroolefins include tetrafluoroethylene, hexafluoropropylene, and mixtures thereof. Among these perfluoroolefins, tetrafluoroethylene is particularly preferred.

Perfluorovinyl ethers are typically perfluoro(alkylvinyl)ethers or perfluoro(alkoxyvinyl)ethers represented by the following formula (III):
CF₂═CFO(R′_{f}O)ₙ(R″_{f}O)ₘR_{f} (III)
wherein R′_{f} and R″_{f} are the same or different and represent a linear or branched perfluoroalkylene group having 2 to 6 carbon atoms, m and n independently represent an integer of 0 to 10, and R_{f} represents a perfluoroalkyl group having 1 to 6 carbon atoms.

Preferable perfluoro(alkylvinyl)ethers include compounds of the following formula (IV):
CF₂═CFO(CF₂CFXO)ₙR_{f} (IV)
wherein X is F or CF₃, n is from 0 to 5, and R_{f} is a perfluoroalkyl group having 1 to 6.

Most preferable perfluoro(alkylvinyl)ethers are compounds of the formula (III) or (IV) wherein n is 0 or 1 and R_{f} has 1 to 3 carbon atoms. Examples of the perfluoro(alkylvinyl)ether include perfluoro(methylvinyl)ether, perfluoro(ethylvinyl)ether, and perfluoro(propylvinyl)ether.

The other perfluoro(alkylvinyl)ether monomer useful in the present invention includes compounds represented by the following formula (V):
CF₂═CFO[(CF₂)ₘCF₂CFZO)ₙR_{f} (V)
wherein R_{f} is a perfluoroalkyl group having 1 to 6 carbon atoms, m is 0 or 1, n is from 0 to 5, and Z is F or CF₃.

Preferable perfluoro(alkylvinyl)ether monomers are compounds wherein R_{f} is C₃F₇, m is 0, and n is 1.

The other perfluoro(alkylvinyl)ether monomer useful in the present invention includes compounds represented by the following formula (VI):
CF₂═CFO[(CF₂CFCF₃O)ₙ(CF₂CF₂CF₂O)ₘ(CF₂)ₚ]CₓF₂ₓ₊₁ (VI)
wherein m and n each represents 0 or an integer of 1 to 10, p is from 0 to 3, and x is from 0 to 5.

The other perfluoro(alkylvinyl)ether useful in the present invention includes compounds represented by the following formula (VII):
CF₂═CFOCF₂CF(CF₃)O(CF₂O)ₘ(C)ₙF₂ₙ₊₁ (VII)
wherein n is from 1 to 5, and preferably 1, and m is from 1 to 3.

Typical examples of the perfluoro(alkylvinyl)ether useful in the present invention include CF₂═CFOCF₂OCF₂CF₂CF₃, CF₂═CFOCF₂OCF₃, CF₂═CFO(CF₂)₃OCF₃, and CF₂═CFOCF₂CF₂OCF₃.

A mixture of the perfluoro(alkylvinyl)ether and the perfluoro(alkoxylvinyl)ether can also be used.

A crosslinking site monomer may be introduced into the perfluoroelastomer to form a crosslinked structure, and thus elastomeric properties are exhibited. The crosslinking site monomer can cause a peroxide curing reaction. In general, preferable crosslinking site monomers have at least one bromine (Br) group or iodine (I) group, and other functional groups capable of participating in a crosslinking reaction such as a nitrile (CN) group.

Examples of preferable Br or I group-containing crosslinking site monomer include bromodifluoroethylene, bromotrifluoroethylene, iodotrifluoroethylene, 4-bromo-3,3,4,4-tetrafluorobutene-1, CF₂═CFOCF₂CF₂Br, CF₂═CFOCF₂CF₂CF₂Br, and CF₂═CFOCF₂CF₂CF₂OCF₂CF₂Br.

Examples of preferable CN-containing crosslinking site monomer include the following compounds.
CF₂═CFO(CF₂)ₙCN (VIII)
CF₂═CFO[CF₂CFCF₃O]ₚCF₂CF(CF₃)CN (IX)
CF₂═CF[OCF₂CFCF₃]ₓO(CF₂)ₘCN (X)
wherein n=2 to 12, p=0 to 4, x=1 to 2, and m=1 to 4. Examples of preferable CN-containing crosslinking site monomer include perfluoro(8-cyano-5-methyl-3,6-dioxa-1-octene).

Bromotrifluoroethylene is particularly useful as the crosslinking site monomer used in the present description.

Particularly preferable perfluoroelastomers include perfluoroelastomers obtained by crosslinking a terpolymer comprising about 50 to 85 mol % of CF₂═CF₂, about 15 to 50 mol % of CF₂═CF(OCF₃) and about 0.2 to 5 mol % of a crosslinking site monomer.

The perfluoroelastomer treated with the tack free treating agent solution of the present invention may be used as a sealing material for semiconductor equipment (for example, dry etching system, CVD system and the like). Since tack free property is imparted to the surface of the treated elastomer, it is possible to prevent adhesion to the surface contacted with an elastomer sealing material, and to prevent fracture of the sealing material due to adhesion.

### EXAMPLES

### Perfluoroelastomer

A 2 mm thick sheet obtained by vulcanization molding of the admixture prepared according to the following formulation by means of the first vulcanization process (170° C./15 minutes) and the second vulcanization process (200° C./16 hours) was subjected to n immersion test described below. The formulation was:

| | | |
|---|---|---|
| Perfluoroelastomer polymer (manufactured by Dyneon Co.) | 100 | Parts |
| Triallyl isocyanurate (manufactured by Nippon Kasei | 2 | Parts |
| Chemical Co., Ltd.) | | |
| Perhexa 25B¹⁾ (manufactured by NOF | 0.6 | Parts |
| CORPORATION) | | |
| MT Carbon (manufactured by Cancarb Co.) | 15 | Parts |

¹⁾Perhexa 25B is 2,5-dimethyl-2,5-bis(t-butylperoxy)hexane.

1): Perhexa 25B is 2,5-dimethyl-2,5-bis(t-butylperoxy)hexane.
The indicated parts are weight basis.

### Immersion

The above test specimen was immersed in a surface treatment solution prepared according to the following formulation at 50° C. for one hour. Then, the test piece was taken out, washed with toluene and dried at 100° C. for one hour.

### Measurement

The resulting test specimen was vertically cut and Si distribution was measured at the region of the depth of 10 μm from the treated surface in the cross-section by elemental analysis using energy-dispersive X-ray spectrometry (EDS).

TABLE 1

| | | | | Comparative | Comparative |
|---|---|---|---|---|---|
| | Example 1 | Example 2 | Example 3 | Example 1 | Example 2 |
| Hydrofluoroether (HFE-7100, manufactured by | 72% | 45% | 36% | 100% | |
| Sumitomo 3M Ltd.) | | | | | |
| Toluene (manufactured by Wako Pure | 18% | 45% | 54% | | 100% |
| Chemicals Industries, Ltd.) | | | | | |
| Tack free treating agent (Silicone Oil KF-96, | 10% | 10% | 10% | 10% | 10% |
| manufactured by Shin-Etsu Chemical Co., Ltd.) | | | | | |
| Appearance of solution | transparent | transparent | transparent | white turbidity | transparent |

Degree of penetration of silicone oil in the vicinity of the surface of perfluoroelastomer

| | | | | | |
|---|---|---|---|---|---|
| Concentration of Si atoms at the region of | 2.7% | 2.4% | 1.9% | 0% | 0% |
| depth of 10 μm from the treated surface | | | | | |

As is apparent from the results of Examples 1 to 3, each silicon oil solution is transparent and each test piece was completely dissolved. The surface analysis revealed penetration of the silicone oil.

On the other hand, in case of excess hydrofluoroether in Comparative Example 1, the silicone oil could not completely dissolved and therefore deposited. In case of excess toluene in Comparative Example 2, although the oil was completely dissolved, the oil has not affinity and swellability to the fluoroelastomer and therefore the silicone oil did not penetrate.

1. A solvent for tack free treating agent for perfluoroelastomer, comprising:
hydrofluoromonoether represented by CₙF₂ₙ₊₁—O—CₘH₂ₘ₊₁ wherein n is from 3 to 7, CₙF₂ₙ₊₁ may be linear or branched, and m is from 1 to 2, and
at least one organic solvent selected from the group consisting of methanol, ethanol, isopropanol (IPA), 1-propanol, t-butyl methyl ether, tetrahydrofuran, diethyl ether, ethyl acetate, butyl acetate, propyl acetate, pentane, hexane, heptane, acetone, methyl ethyl ketone (MEK), methyl isobutyl ketone (MIBK), cyclohexanone, trans-1,2-dichloroethylene, 1,2-dichloropropane, methylene chloride, trichloroethylene, perchloroethylene, toluene, xylene, trifluorotoluene, and hexafluoroxylene.

2. The solvent for tack free treating agent for perfluoroelastomer according to claim 1, wherein said hydrofluoromonoether is contained in an amount of 40 to 80% by weight, based on the weight of the solvent and said organic solvent is contained in an amount of 20 to 60% by weight, based on the weight of the solvent.

3. A solvent for tack free treating agent for perfluoroelastomer, comprising:
hydrofluoromonoether represented by CₙF₂ₙ₊₁—O—CₘH₂ₘ₊₁ (wherein n is from 3 to 7, CₙF₂ₙ₊₁ may be linear or branched, and m is from 1 to 2),
a perfluoro-based solvent represented by the following formula: 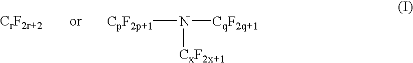
wherein r is from 4 to 10, p is from 1 to 8, q is from 1 to 8, x is from 1 to 8, and p+q+x=6 to 10, and
at least one organic solvent selected from the group consisting of methanol, ethanol, isopropanol (IPA), 1-propanol, t-butyl methyl ether, tetrahydrofuran, diethyl ether, ethyl acetate, butyl acetate, propyl acetate, pentane, hexane, heptane, acetone, methyl ethyl ketone (MEK), methyl isobutyl ketone (MIBK), cyclohexanone, trans-1,2-dichloroethylene, 1,2-dichloropropane, methylene chloride, trichloroethylene, perchloroethylene, toluene, xylene, trifluorotoluene, and hexafluoroxylene.

4. The solvent for tack free treating agent for perfluoroelastomer according to claim 3, wherein said hydrofluoromonoether is contained in an amount of 40 to 80% by weight, based on the weight of the solvent, said perfluoro-based solvent is contained in an amount of not more than 10% by weight, based on the weight of the solvent, and said organic solvent is contained in an amount of 20 to 60% by weight, based on the weight of the solvent.

5. A tack free treating agent solution for perfluoroelastomer, comprising the solvent according to claim 1, and a silicone-based tack free treating agent.

6. The tack free treating agent solution for perfluoroelastomer according to claim 5, wherein said silicone-based tack free treating agent is a polymer comprising a dimethylsiloxane repeating unit.
